(19) United States
(12) Patent Application Publication
(10) Pub. No.: US 2024/0383208 A1
(43) Pub. Date: Nov. 21, 2024

(54) INCREMENTAL BUILD MATERIAL SPREAD

(71) Applicant: HEWLETT-PACKARD DEVELOPMENT COMPANY, L.P., Spring, TX (US)

(72) Inventors: Krzysztof NAUKA, Palo Alto, CA (US); Michelle NIU, Palo Alto, CA (US)

(73) Assignee: HEWLETT-PACKARD DEVELOPMENT COMPANY, L.P., Spring, TX (US)

(21) Appl. No.: 18/693,897

(22) PCT Filed: Sep. 21, 2021
(86) PCT No.: PCT/US2021/071532

§ 371 Date: Mar. 20, 2024

(51) Int. Cl. B29C 64/393; B22F 10/14; B22F 10/37; B22F 12/60; B28B 1/00; B28B 17/00; B29C 64/165; B29C 64/194; B29C 64/214; B29C 64/218; B33Y 10/00; B33Y 30/00; B33Y 50/02

(52) U.S. Cl. CPC B29C 64/393; B22F 10/14; B22F 10/37; B22F 12/60; B28B 1/001; B28B 17/0081; B29C 64/165; B29C 64/194; B29C 64/214; B29C 64/218; B33Y 10/00; B33Y 30/00; B33Y 50/02

(57) ABSTRACT

In one example in accordance with the present disclosure, an additive manufacturing system is described. The additive manufacturing system includes a bed moveable in a vertical direction. The bed is to receive a build material that is to form a three-dimensional (3D) printed object. The additive manufacturing system also includes a build material depositor to deposit the build material on the bed and a build material spreader to traverse across the bed to spread the build material. The additive manufacturing system also includes a solidification system to selectively solidify a layer of build material. The additive manufacturing system also includes a controller. The controller is to lower the bed by a first amount in preparation for receiving build material and iteratively raise the bed in increments in between passes of the build material spreader across the bed, wherein an increment is a portion of the first amount.

### BACKGROUND

Additive manufacturing systems produce three-dimensional (3D) objects by building up layers of material. Some additive manufacturing systems use inkjet or other printing technology to apply some of the manufacturing materials. Additive manufacturing systems make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system for incrementally spreading a build material, according to an example of the principles described herein.

FIG. 2 is a side view of an additive manufacturing system for incrementally spreading a build material, according to an example of the principles described herein.

FIG. 3 is a flow chart of a method for incrementally spreading a build material, according to an example of the principles described herein.

FIGS. 4A-4D are views of the incremental spread of build material, according to an example of the principles described herein.

FIG. 5 is a flow chart of a method for incrementally spreading a build material, according to an example of the principles described herein.

FIGS. 6A-6D are top views of an additive manufacturing system for incrementally spreading a build material, according to an example of the principles described herein.

FIG. 7 is a graph depicting the surface roughness of build material following incremental spreads of a build material, according to an example of the principles described herein.

FIG. 8 depicts a non-transitory machine-readable storage medium for incrementally spreading a build material, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) printed object through the solidification of layers of build material. Additive manufacturing systems make objects based on data in a 3D model of the object generated, for example, with a computer-aided design (CAD) computer program product. The model data is processed into slices, each slice defining portions of a layer of build material that are to be solidified.

In one particular example, a powder build material is deposited and a binding agent is selectively applied to the layer of powder build material. The binding agent is deposited in a pattern of a slice of a 3D object to be printed. This process is repeated per layer until the 3D object is formed. Such a binding-agent-based system may be used to generate metallic, plastic, or ceramic 3D objects.

With a 3D object formed, the binding agent is cured to form a “green” 3D object. Cured binding agent holds the build material of the green object together. The binding agent is activated or cured by heating the binding agent to about the melting point of the solvent in the binding agent. When activated or cured, the binding agent glues the powder build material particles into the cured green object shape. This process is repeated in a layer-wise fashion to generate a green 3D object. The cured green object has enough mechanical strength such that it is able to withstand extraction from the build material platform without being deleteriously affected (e.g., the shape is not lost).

The green 3D object may then be placed in an oven to expose the green 3D object to electromagnetic radiation and/or heat to sinter the build material in the green 3D object to form the finished 3D object. Specifically, the binding agent is removed and the temperature is further raised such that sintering of the powder metal particles occurs to form a 3D object.

While in the oven, further heating is applied to sinter the 3D object wherein the already partially melted build material is further solidified to increase its densification to at least about 95 percent densification, in some examples. In some examples, such as when the build material comprises a metal powder material, such sintering temperatures may range between 600 degrees Celsius to about 1700 degrees Celsius. It is to be understood that the term “green” does not connote color, but rather indicates that the part is not yet fully processed.

In another example, to form a 3D object out of plastic material, a build material, which may be powder, is deposited on a bed. A fusing agent is then dispensed onto portions of a layer of build material that are to be fused to form a layer of the 3D object. The system that carries out this type of additive manufacturing may be referred to as a powder and fusing agent-based system. The fusing agent disposed in the desired pattern increases the energy absorption of the layer of build material on which the agent is disposed. The build material is then exposed to energy such as electromagnetic radiation. The electromagnetic radiation may include infrared light, ultraviolet light, laser light, or other suitable electromagnetic radiation. Due to the increased heat absorption imparted by the fusing agent, those portions of the build material that have the fusing agent disposed thereon heat to a temperature greater than the fusing temperature for the build material.

Accordingly, as energy is applied to a surface of the build material, the build material that has received the fusing agent, and therefore has increased energy absorption, fuses while that portion of the build material that has not received the fusing agent remains in powder form. Those portions of the build material that receive the agent and thus have increased heat absorption may be referred to as fused portions. By comparison, the applied heat does not increase the temperature of the portions of the build material that are free of the agent to this fusing temperature. Those portions of the build material that do not receive the agent and thus do not have increased heat absorption may be referred to as unfused portions.

Accordingly, a predetermined amount of heat is applied to an entire bed of build material, the portions of the build material that receive the fusing agent, due to the increased heat absorption imparted by the fusing agent, fuse and form the object while the unfused portions of the build material are unaffected, i.e., not fused, in the presence of such application of thermal energy. This process is repeated in a layer-wise fashion to generate a 3D object. The unfused portions of material can then be separated from the fused portions, and the unfused portions recycled for subsequent 3D formation operations.

In yet another example, a laser, or other power source is selectively aimed at a powder build material, or a layer of a powder build material, to form a slice of a 3D printed part. Such a process may be referred to as selective laser sintering. In yet another example, the additive manufacturing process may use selective laser melting where portions of the powder material, which may be metallic, are selectively melted together to form a slice of a 3D printed part. A device which carries out any of these additive manufacturing processes may be referred to as an additive manufacturing device and in some cases a printer.

While such additive manufacturing operations have greatly expanded manufacturing and development possibilities, further development may make 3D printing a part of even more industries. For example, powder bed-based additive manufacturing relies on reproducible spreading and selective solidification of each layer of the 3D printed object. Control of spreading and build material density uniformity of spread layers may be particularly relevant in binder-jet metal printing where printed green objects are to be further sintered to achieve high density metal parts.

Layer formation includes the operations of depositing build material over a bed or a previously deposited layer and spreading the build material with a build material spreader such as a roller or blade, in order to produce a uniform and smooth layer with a desired thickness and high packing density. However, the horizontal force from the build material spreader distributing the build material particles may be counteracted by interparticle frictional forces between individual particles of the build material and the inertia of deposited material. That is, as the build material spreader attempts to evenly spread build material particles, the opposing forces 1) may form clumps of build material, which prevent particles from being spread or 2) may displace particles in the previous layer from their resting position on the bed. These interparticle interactions may result in gaps, pockets, or other imperfections along the build material surface. That is, the mechanical interlocking of adjacent particles and other forms of particle interactions makes uniform spreading difficult.

This frictional force depends on the relative positions of the interacting particles, their shape and size, instantaneous positions, and surface properties. For example, metallic build material particles may be non-spherical and may have different sizes relative to one another. The effect of the interparticle interactions increases with the number of particles acted upon. That is, the larger the amount of build material that is to be spread, the more impact the frictional and other interparticle forces may have on the uniformity, density, and smoothness of a deposited layer. Accordingly, spreading build material in a single pass may result in displaced build material, which may result in gaps, pockets, or other imperfections in the build material layer. Such pockets and/or gaps may result in mechanical and geometrical defects and weaknesses in a resulting 3D printed object.

Accordingly, the present specification describes systems and methods for addressing these and other issues. Specifically, the present systems and methods spread small volumes so as to reduce the volume of disturbed particles. Specifically, the present system includes a bed to receive build material, a build material depositor to deliver the build material to the bed, and a build material spreader to smooth the build material across the bed. The build material spreader is to spread the build material using multiple passes across the bed without receiving additional powder during the multiple passes.

According to the present systems and methods, build material is spread with a series of spread passes rather than a single pass while simultaneously advancing a bed height. As such, formation of a single layer of build material can be split into several increments with small amounts of build material being pushed by the build material spreader in each increment. The spreading of a small layer may be controlled with help of small vertical displacements of the bed in between passes of the build material spreader. As a result, a smaller amount of build material is spread so as to not disturb the surrounding build material. As such, the quantity and effect of interparticle forces is reduced resulting in a smoother finish per pass. This is repeated a number of times until a desired thickness of the build material is deposited after which a solidifying process or agent is deposited.

Specifically, the present specification describes an additive manufacturing system. The additive manufacturing system includes a bed moveable in a vertical direction. The bed receives a build material that is to form a three-dimensional (3D) printed object. The additive manufacturing system also includes a build material depositor to deposit the build material on the bed and a build material spreader to traverse across the bed to spread the build material. The additive manufacturing system also includes a solidification system to selectively solidify a layer of build material. The additive manufacturing system also includes a controller to 1) lower the bed by a first amount in preparation for receiving build material and 2) iteratively raise the bed in increments in between passes of the build material spreader across the bed, wherein an increment is a portion of the first amount.

The present specification also describes a method. According to the method, a bed of an additive manufacturing system is lowered from an initial position by a first amount. The first amount is greater than a target thickness for a layer of a 3D printed object. A build material depositor deposits an amount of build material to form the layer of the 3D printed object. In some examples, the amount of build material may exceed a volume of a formed layer of the 3D printed object. A controller determines a difference between the first amount and the target layer thickness and divides the difference into multiple increments. In an iterative fashion, the bed is raised by an increment and a build material spreader is traversed across the bed to spread a portion of the build material across the bed.

The present specification also describes a non-transitory machine-readable storage medium encoded with instructions executable by a processor. The machine-readable storage medium includes instructions to deposit an amount of build material to form a layer of a 3D printed object on a bed of an additive manufacturing system, lower the bed by an amount equal to a target layer thickness for the layer of the 3D printed object, and lower the bed by an additional amount. The machine-readable storage medium also includes instructions executable by the processor to cause the processor to divide the additional amount into multiple increments and iteratively raise the raisable bed by an increment and traverse a build material spreader across the bed to spread a portion of the build material across the bed.

Accordingly, rather than spreading the entire amount of build material that is to form a single layer of a 3D printed object in one pass, potentially resulting in surface imperfections on the build material, the present systems and methods spread the amount in increments. Doing so decreases the interparticle forces that generate surface imperfections as a smaller amount of build material is spread per pass.

Accordingly, such systems and methods may 1) provide a smoother and more uniform surface for a layer of build material, 2) decrease mechanical defects in the 3D printed object; 3) increase geometric uniformity across the 3D printed object; 4) increase density of the layer and 5) enhance the properties of a 3D printed object formed with non-spherical and non-uniform build material particles. However, it is contemplated that the systems and methods disclosed herein may address other matters and deficiencies in a number of technical areas.

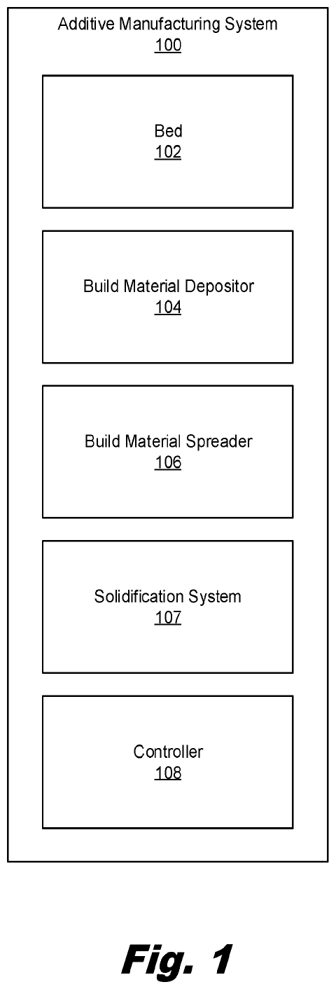

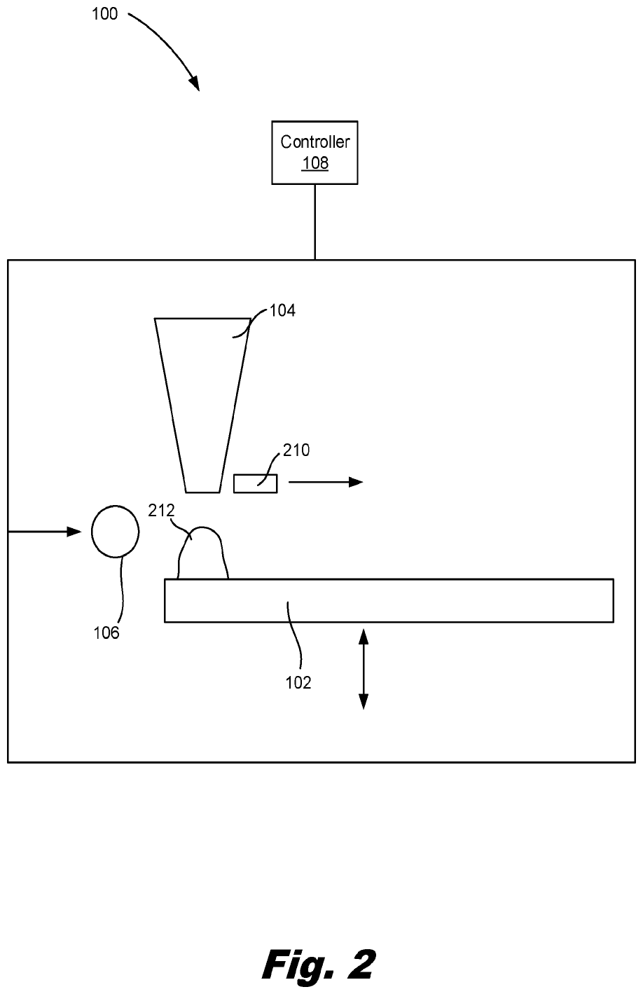

Turning now to the figures, FIG. 1 is a block diagram of an additive manufacturing system (100) for incrementally spreading a build material, according to an example of the principles described herein. In general, apparatuses for generating 3D objects may be referred to as additive manufacturing systems (100). The additive manufacturing system (100) described herein may correspond to three-dimensional printing systems, which may also be referred to as three-dimensional printers. An additive manufacturing system (100) may use a variety of operations. For example, the additive manufacturing system (100) may be an agent-based system (as depicted in FIG. 2). While FIG. 2 depicts a specific example of an agent-based system (100), the additive manufacturing system (100) may be any of the above-mentioned systems (100) or another type of additive manufacturing system (100).

The additive manufacturing system (100) may include a bed (102) that is moveable in the vertical direction. The bed (102) is to receive a build material that is to form a 3D printed object. That is, in an example of an additive manufacturing process, a layer of build material may be formed in a build area. As used in the present specification and in the appended claims, the term “build area” refers to an area of space wherein the 3D printed object is formed. The build area may refer to a space bounded by a bed (102). The build area may be defined as a three-dimensional space in which the additive manufacturing system (100) can fabricate, produce, or otherwise generate a 3D printed object. That is, the build area may occupy a three-dimensional space on top of the bed (102) surface. In one example, the width and length of the build area can be the width and the length of bed (102) and the height of the build area can be the extent to which bed (102) can be moved in the z-direction. Although not shown, an actuator, such as a piston, can control the vertical position of bed (102).

The bed (102) may accommodate any number of layers of build material. For example, the bed (102) may accommodate up to 4,000 layers or more. In an example, a number of build material supply receptacles may be positioned alongside the bed (102). Such build material supply receptacles source the build material that is placed on the bed (102) in a layer-wise fashion.

The additive manufacturing system (100) may include a build material depositor (104) to deposit layers of powder build material on the bed (102). This powder build material may be the raw material from which a 3D object is formed. That is, portions of the powder build material that are joined together form a solid structure. Each layer of the build material that is fused in the bed (102) forms a slice of the 3D printed object such that multiple layers of fused build material form the entire 3D printed object.

The build material depositor (104) may acquire build material from build material supply receptacles, and deposit acquired build material as a layer in the bed (102), which layer may be deposited on top of other layers of build material already processed that reside in the bed (102). In some examples, the build material depositor (102) may be coupled to a scanning carriage. That is, the build material depositor (102) may traverse across the bed (102) to deposit the build material. In operation, the build material depositor (104) places build material in the bed (102) as the scanning carriage moves over the bed (102) along the scanning axis. In another example, the build material depositor (104) is stationary relative to the bed (102). For example, the build material depositor (104) may deposit build material on a side of the region of the bed (102) where the 3D printed object is to be formed.

The powder build material may be of a variety of types. For example, the build material may be a metal material, such as a metal powder. The metal powder build material may include metallic particles such as steel, bronze, titanium, aluminum, nickel, cobalt, iron, nickel cobalt, gold, silver, platinum, copper and alloys of the aforementioned metals. While several example metals are mentioned, other alloy build materials may be used in accordance with the principles discussed herein. In other examples, the build material may be a ceramic build material. In some examples, the build material may comprise a polymer material. For example, the polymer material may be a polyamide material. While specific reference is made to a polyamide material, the polymer material may be of other types including, thermoplastic materials, resin, carbon-fiber enhanced resin, polyurethane, thermoplastic polyurethane (TPU), polyetheretherketone (PEEK), and the like.

The amount of build material that is deposited may be larger than or equal to the amount to form a layer of the 3D printed object. That is, each layer of the 3D printed object may require a particular amount of build material to form. The build material depositor (104) may deposit at least this amount on the bed (102) such that a layer of the desired thickness may be formed.

The additive manufacturing system (100) also includes a build material spreader (106) to traverse across the bed (102) to spread the build material. That is, in some examples, the build material depositor (104) may deposit a rough layer of build material across the entire bed (102). In this example, the build material spreader (106) may traverse across the bed (102) to re-distribute the build material in a smoother coating over the bed (102). In another example, the build material depositor (104) may deposit a pile of build material along an edge of the bed (102). In this example, the build material spreader (106) may move the build material from the edge of the bed (102) across the body of the bed (102) to generate a smooth surface on which a solidifying agent is deposited. Put another way, the build material spreader (106) may precisely redistribute (or recoat) the deposited powder build material into a layer of a desired thickness. The build material spreader (106) may take a variety of forms including a roller or doctor blade.

The additive manufacturing system (100) also includes a solidification system (107) to selectively solidify a layer of the 3D printed object. That is, as described above, the additive manufacturing system (100) may implement any number of mechanisms to solidify a layer of the build material. In a fusing-agent based system, the mechanism may be a fusing agent. In a binding-agent based system, the mechanism may be a binding agent. In these examples, the solidification system may be a fluid ejection system. In selective laser sintering and selective laser melting, the solidification system (107) may include the laser that solidifies the powder build material.

The additive manufacturing system (100) also includes a controller (108) to control the additive manufacturing operations. That is, the controller (108) instructs the build material depositor (104) and solidification system (107) in the formation of the 3D printed object. Specifically, in a fusing agent-based system, the controller (108) may direct a build material depositor (104) to add a layer of build material. Further, the controller (108) may send instructions to direct a printhead of an agent distributor to selectively deposit the agent(s) onto the surface of a layer of the build material. The controller (108) may also direct the printhead to eject the agent(s) at specific locations to form a 3D printed object slice. As such, each of the previously described physical elements may be operatively connected to a controller (108) which controls the additive manufacturing.

Specifically, the controller (108) may lower the bed (102) by a first amount in preparation for receiving build material. That is, after a layer of build material is deposited and solidified, a piston or other actuator coupled to the bed (102) lowers the bed (102) in a z-direction. In an example, this first amount is greater than a target thickness of a layer of the 3D printed object.

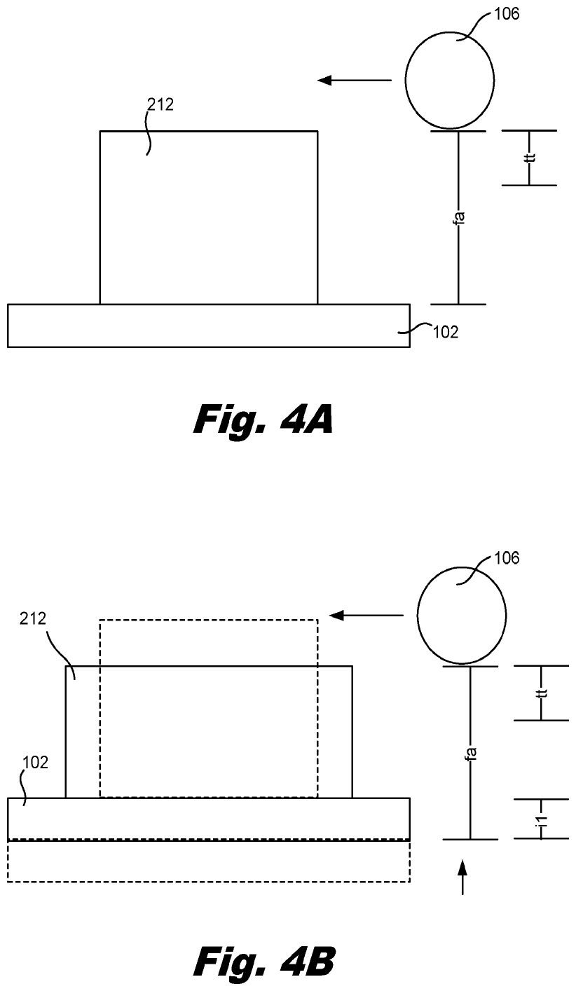

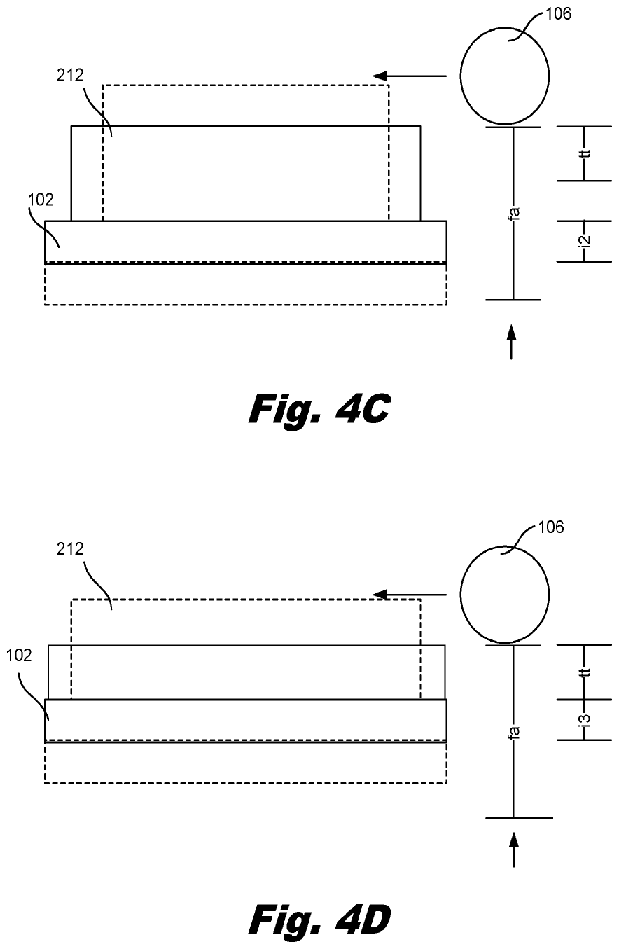

Following deposition of a sufficient amount of build material to form a single layer of the 3D printed object, the controller (108) iteratively raises the bed (102) in increments in between passes of the build material spreader (106) across the bed (102), wherein an increment is a portion of the first amount. That is, in a cyclic fashion, the controller (108) raises the bed (102) a small amount and then instructs the build material spreader (106) to traverse across the bed (102), thus pushing a portion of the powder build material across the bed (102). That is, rather than pushing the build material across the bed (102) in a single pass, the controller (108) incrementally spreads the build material by iteratively raising the bed (102) and directing the build material spreader (106) such that a portion of the amount of build material that is to form the layer is spread at a time. As noted above, doing so reduces the amount of interparticle interactions as a reduced amount of build material is spread per pass. Pictorial examples of the incremental raising of the bed (102) and activation of the build material spreader (106) is provided above in connection with FIGS. 4A-4D.

As a specific numeric example, a target thickness for a build material layer may be 80 microns. Accordingly, the controller (108) may drop the bed (102) from an initial position, by an amount greater than 80 microns, for example 160 microns. After the build material depositor (104) has deposited an amount of build material sufficient to fully form an 80-micron thick layer, the controller (108) may raise the bed (102) by an increment, for example 20 microns, and the build material spreader (106) may spread a top portion of the deposited amount. Again, the controller (108) may raise the bed (102) by an increment, for example another 20 microns, such that the bed height is now 120 microns below the initial position and the build material spreader (106) may again spread a top portion of the deposited build material. This cycle may continue for two more iterations such that the bed (102) is at a distance below its initial position that matches the target thickness, i.e., 80 microns, with a uniform layer of build material having been deposited in preparation for receipt of a solidifying agent. In other words, the first amount by which the bed (102) is dropped is greater than a target thickness of a layer of a 3D printed object and the bed (102) is incrementally raised until it reaches a distance below the build material spreader (106) that is equal to the target thickness. As such, the build material associated with a single layer of the 3D printed object is spread in multiple passes of the build material spreader (106) following iterative raises of the bed (102). While particular reference is made to a certain number of iterations of raising the bed and traversing the build material spreader (106), the present controller (108) may perform three or more, four or more, five or more, six or more, or additional counts of iterations of raising/spreading to form a volume of build material to form a single layer of the 3D object. Note that during the iterations of raising and spreading build material, the additive manufacturing system (100) does not deposit agent or deliver fusing energy (other than preheating). That is, in an example, the controller (108) does not deposit agent or fusing agent until a volume of material equal to the target thickness is achieved, which may be after multiple (i.e., three or more, four or more, five or more, six or more, or other values) iterations of raising the bed (102) and traversing the build material spreader (106) across the bed (102) to spread the build material.

The controller (108) may include various hardware components, which may include a processor and memory. The processor may include the hardware architecture to retrieve executable code from the memory and execute the executable code. As specific examples, the controller (108) as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (108) cause the controller (108) to implement at least the functionality of building a 3D printed object.

As such, the present additive manufacturing system (100) provides a multi-pass spreading of build material to provide build material layers with uniform thickness. The additive manufacturing system (100) may be particularly suited for applications with strongly-interacting build material particles when moved with respect to each other like, for example, non-spherical particles.

FIG. 2 is a side view of an additive manufacturing system (100) for incrementally spreading a build material (212), according to an example of the principles described herein. Components of the additive manufacturing system (100) depicted in FIG. 2 may not be drawn to scale and thus, the additive manufacturing system (100) may have a different size and/or configuration other than as shown therein.

As described above, a build material depositor (104) may drop powder build material (212) onto the bed (102). The build material depositor (104) is arranged to dispense a build material layer-by-layer onto the bed (102) to additively form the 3D object. A build material spreader (106) or other mechanism may precisely redistribute (or recoat) the deposited powder build material into a layer of a desired thickness by traversing across the bed (102) in a horizontal direction and moving a portion of the deposited build material (212) across the bed (102).

While FIG. 2 depicts a particular build material depositor (104), the build material depositor (104) may include a variety of devices such as a sieve or rotating slotted rod to roughly dispense the build material. Moreover, while FIG. 2 depicts a particular build material spreader (106), the build material spreader (106) may be implemented via a variety of electromechanical or mechanical mechanisms, such as doctor blades, rollers, slot dies, extruders, and/or other structures suitable to spread, deposit, and/or otherwise form a coating of the build material in a generally uniform layer relative to the bed (102) or relative to a previously deposited layer of build material.

As described above, the bed (102) may be moveable in a vertical direction. Prior to deposition of the build material (212), the bed (102) may be dropped by an amount greater than a target thickness of a layer. Following deposition of the build material (212) and in between passes of the build material spreader (106), the controller (108) may raise the bed (102) incrementally to spread the build material (212) in stages. Following spreading of the build material (212), the layer may be hardened by the solidification system (FIG. 1, 107). In the particular example depicted in FIG. 2, an agent distribution system (210) deposits an agent, such as a fusing agent or a binding agent, onto the powder build material (212).

That is, the additive manufacturing system (100) may include an agent distribution system (210) to deposit an agent on a layer of powder build material (212) in a pattern to form a slice of a 3D object. For example, if a 3D object to be formed is a cube, the agent distribution system (210) may deposit the agent in a square pattern to form a square slice of the 3D cube.

The agent distribution system (210) may distribute a variety of agents. One specific example of an agent is a fusing agent, which increases the energy absorption of portions of the build material (212) that receive the fusing agent to selectively solidify portions of a layer of powdered build material (212). The agent distribution system (210) may deposit other agents to form the 3D printed object. For example, the agent distribution system (210) may deposit a binder agent that temporarily glues portions of the 3D printed object together.

In either example, the agent distribution system (210) may include at least one liquid ejection device to distribute the agent onto the layers of build material (212). A liquid ejection device may include at least one printhead (e.g., a thermal ejection based printhead, a piezoelectric ejection based printhead, etc.). In some examples, the agent distribution system (210) is coupled to a scanning carriage, and the scanning carriage moves along a scanning axis over the bed (102). In one example, printheads that are used in inkjet printing devices may be used in the agent distribution devices. In other examples, the agent distribution system (210) may include other types of liquid ejection devices that selectively eject small volumes of liquid.

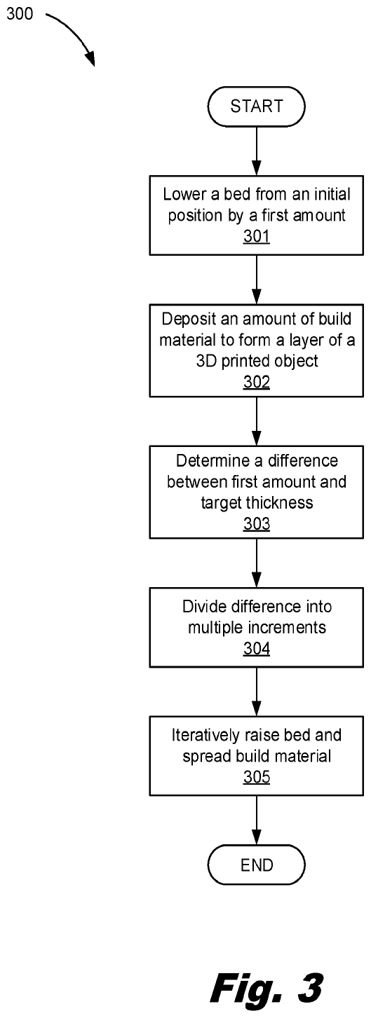

FIG. 3 is a flow chart of a method (300) for incrementally spreading a build material (FIG. 2, 212), according to an example of the principles described herein. As described above, additive manufacturing involves the layer-wise deposition of build material (FIG. 2, 212) and curing or fusing certain portions of a layer to form a slice of a 3D object. Accordingly, in this example, the method (300) includes sequentially forming slices of a 3D object. For each layer of the 3D object, the bed (FIG. 1, 102) is lowered (block 301) from an initial position by a first amount. The initial position may be the position the bed (FIG. 1, 102) is in following the formation of a previous layer. As described above, this first amount by which the bed (FIG. 1, 102) is lowered may be greater than a target thickness for a layer of the 3D printed object. A specific numeric example follows a description of the method (300). To lower the bed (FIG. 1, 102), the controller (FIG. 1, 108) may pass a signal to a motor, piston, or other actuator to drop the bed (FIG. 1, 102) in a z-direction as indicated in FIG. 2.

The build material depositor (FIG. 1, 104) then deposits (block 302) an amount of build material (FIG. 2, 212) to form the layer of the 3D printed object. That is, a length and width of the bed (FIG. 1, 102) along with a target thickness for a layer provide a volume. The build material depositor (FIG. 1, 104) may deposit an amount of build material (FIG. 2, 212) to fill, or overfill, this volume. As described above, this deposition may be to the side of a region of the bed (FIG. 1, 102) where the 3D printed object is to be formed or may be across an entire region of the bed (FIG. 1, 102) where the 3D printed object is to be formed.

The controller (FIG. 1, 108) then determines (block 303) a difference between the first amount and the target layer thickness and divides (block 304) the difference into multiple increments. This difference represents the total amount that the bed (FIG. 1, 102) is to be raised. The controller (FIG. 1, 108) then iteratively (block 305) raises the bed by an incremental amount and traverses the build material spreader (FIG. 1, 106) across the bed (FIG. 1, 102) to spread a portion of the build material (FIG. 2, 212) across the bed (FIG. 1, 102). Note that the size of the increment may be based on any number of criteria including a desired number of passes. For example, if a target thickness for a layer of build material (FIG. 2, 212) is 100 microns and the desire is to spread the build material (FIG. 2, 212) in 10 passes, the increment size, or size by which the bed (FIG. 1, 102) is raised between each pass of the build material spreader (FIG. 1, 106), may be 10 microns.

In another example, the increment may be a set amount, for example, between 10 and 80 microns thick. In yet another example, the increment thickness may be determined based on a property of a particle of the build material (FIG. 2, 212). That is, different build material particles have different properties such as size, surface roughness, and/or shape. Accordingly, the thickness of an increment may be selected based on such properties. For example, if build material (FIG. 2, 212) particles have average diameters of 20 microns, the incremental thickness may be set to 25 microns. In another example, smaller increments may be selected, for example with particles that are non-spherical and for which the interparticle friction is higher.

In yet another example, different increments may have different increment thicknesses. That is, increments may not be equal to one another. In a particular example, increments near the underlying hardened layer have a larger increment than those that are further away from the underlying hardened layer. In another example, increments near the underlying hardened layer have a smaller increment than those that are further away from the underlying hardened layer.

As a particular example, increments nearer a surface of the 3D printed object may be thinner than increments further away from the surface of the 3D printed object. For example, an interior portion of a 3D printed object may be more accepting of geometrical variation as the interior portion is not seen and not subject to external forces. Accordingly, for these interior layers, a build material (FIG. 2, 212) layer may be formed in fewer passes, which may result in a rougher and less uniform surface. However, any imperfection that may result, may not have an impact on the overall part dimensions. By comparison, on an outer surface of the 3D object, it may be desirable to ensure high dimensional accuracy and that certain engineering tolerances are met. Accordingly, these outer layers of the 3D object may be spread by more passes of reduced volume, thus ensuring a higher accuracy in these regions notwithstanding any imperfections in the inner surface where fewer and larger passes were implemented to spread the build material.

In yet another case, increment thickness may depend on the desired quality of the printed object. For example, printed objects, or portions of a printed object, with less restrictive tolerances may be printed using larger increments.

As described above, these operations (blocks 301-306) may be repeated to iteratively build up multiple patterned layers and to form the 3D object. For example, the controller (FIG. 1, 108) may execute instructions to cause the bed (FIG. 1, 102) to be lowered to enable the next layer of powder build material (FIG. 2, 212) to be spread. In addition, following the lowering of the bed (FIG. 1, 102), the controller (FIG. 1, 108) may 1) control the build material depositor (FIG. 1, 104) to form another layer of powder build material (FIG. 2, 212) particles on top of the previously formed layer, 2) control the bed (FIG. 1, 102) and build material spreader (FIG. 1, 106) to iteratively raise and spread build material (FIG. 2, 212), and 3) control the agent distribution system (FIG. 2, 210) to selectively deposit agent to form another slice of the 3D object.

FIGS. 4A-4D are views of the incremental spread of build material (212), according to an example of the principles described herein. Specifically, each of FIGS. 4A-4D depict a side view of various components, specifically the bed (102) with build material (212) deposited thereon and the build material spreader (106). As depicted in FIG. 4A, the bed (102) is lowered by a first amount, fa, which first amount is greater than a target thickness, tt, for the layer of the 3D printed object.

As depicted in FIG. 4B, the bed (102) is raised by a first increment, if, which first increment is a portion of the difference between the first amount, fa, and the target thickness, tt. In FIG. 4B, the bed (102) position prior to the raising by the first increment, if, is depicted in dashed lines. The build material (212) volume before the first pass of the build material spreader (106) is deposited in dashed lines. As such, when the build material spreader (106) traverses across the bed (102), a portion of the pile of build material (212) is spread across the bed (102) as depicted in FIG. 4B. Moreover, the build material (212) that was deposited from FIG. 4A is thinned such that a greater portion of the bed (102) is covered by build material (212).

As depicted in FIG. 4C, the bed (102) is raised by a second increment, i2, which second increment is a portion of the difference between the first amount, fa, and the target thickness, tt. In FIG. 4C, the bed (102) position prior to the raising by the second increment, i2, is depicted in dashed lines. The build material (212) volume before the second pass of the build material spreader (106) is deposited in dashed lines. As such, when the build material spreader (106) traverses across the bed (102), a portion of the pile of build material (212) is spread across the bed (102) as depicted in FIG. 4C. Moreover, the build material (212) that was spread from FIG. 4B is further thinned such that a greater portion of the bed (102) is covered by build material (212).

As depicted in FIG. 4D, the bed (102) is raised by a third increment, i3, which third increment is a portion of the difference between the first amount, fa, and the target thickness, tt. In FIG. 4D, the bed (102) position prior to the raising by the third increment, i3, is depicted in dashed lines. The build material (212) volume before the third pass of the build material spreader (106) is deposited in dashed lines. As such, when the build material spreader (106) traverses across the bed (102), a portion of the pile of build material (212) is spread across the bed (102) as depicted in FIG. 4D. Moreover, the build material (212) that was spread from FIG. 4C is further thinned such that a greater portion of the bed (102) is covered by build material (212). While FIGS. 4A-4D depict three passes that are uniform in height, as described above any number of passes may be used to spread the build material (212) and in some cases, the incremental thicknesses may not be uniform.

FIGS. 4A-4D depict an example where the bed (102) is initially partially covered with build material (212) and where following a last pass, the entirety of the bed (102) is covered with build material. In another example, the bed (102) may initially be fully covered with build material (212). That is, with each pass, the bed (102) is fully covered with build material (212). In this example, following each pass of the build material spreader (106), as the build material (212) is thinned, excess build material (212) may spill off the edges of the bed (102) into a waste receptacle or waste transport system.

A specific numeric example follows. In this example, the bed (102) may be at an initial position 0 and a target thickness may be x. In this example, the bed (102) is lowered by a first amount equal to y, where y is greater than x. As such, the position of the bed (102) is −y. The bed (102) is raised by an increment which may be equal to a portion of y-x, where the portion size is dependent upon the number of increments. The build material (212) is pushed by the build material spreader (106). This process is repeated until the bed (102) reaches a position of −x. At this point, the bed (102) is at a position below its initial position by an amount equal to the target thickness of the layer.

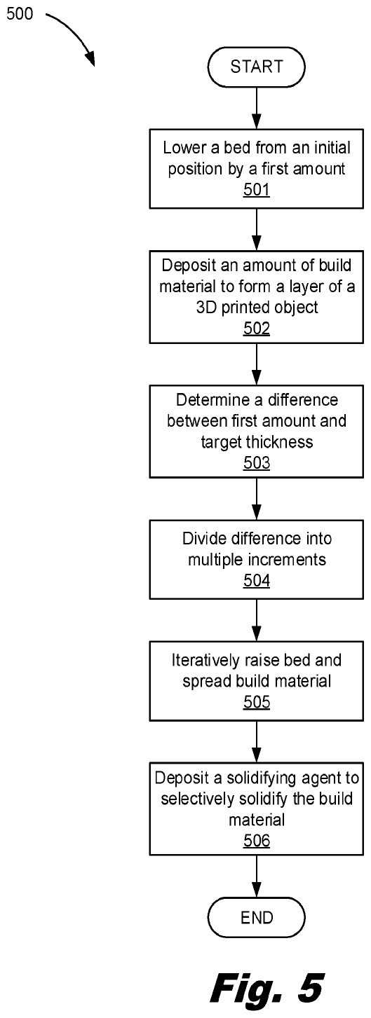

FIG. 5 is a flow chart of a method (500) for incrementally spreading a build material (FIG. 2, 212), according to an example of the principles described herein. According to the method (500), a bed (FIG. 1, 102) is lowered (block 503) by a first amount and an amount of build material (FIG. 2, 212) sufficient to form a layer of a 3D printed object is deposited (block 502). These operations may be performed as described above in connection with FIG. 3. A difference between the first amount and the target thickness is determined (block 503) and divided (block 504) into multiple increments. The controller (FIG. 1, 108) then iteratively (block 505) raises the bed (FIG. 1, 102) and spreads the build material (FIG. 2, 212). These operations may be performed as described above in connection with FIG. 3.

Following a last pass of the build material spreader (FIG. 1, 106), that is after the bed (FIG. 1, 102) is at a distance below the build material spreader (FIG. 1, 106) equal to the target thickness, a solidifying agent is deposited (block 506) on the layer of build material (FIG. 2, 212) to selectively solidify the build material (FIG. 2, 212) to form the layer of the 3D printed object. As described above, the agent may be a binding agent to glue build material (FIG. 2, 212) particles together or may be a fusing agent to melt plastic build material (FIG. 2, 212) particles together. These deposition operations may include sequential activation, per slice, of a build material depositor (FIG. 1,104) and an agent distribution system (FIG. 2, 210) and the scanning carriages to which they may be coupled so that each distributes a respective composition across the surface.

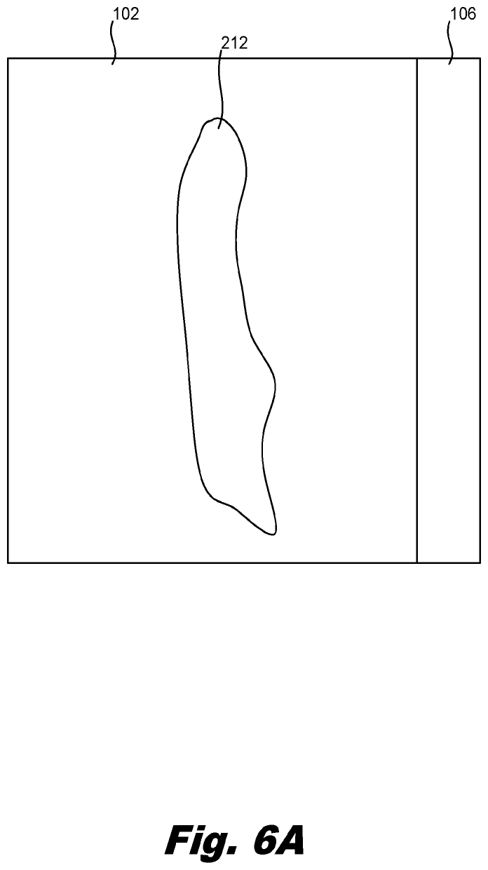

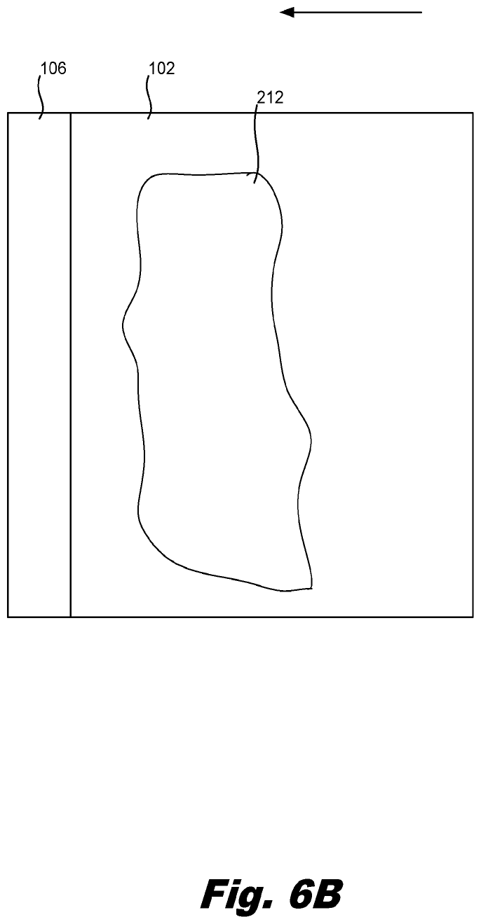

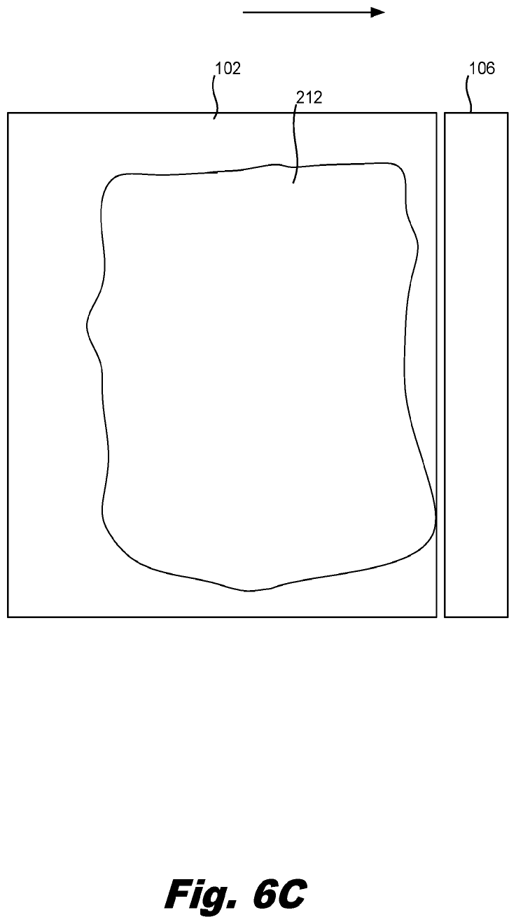

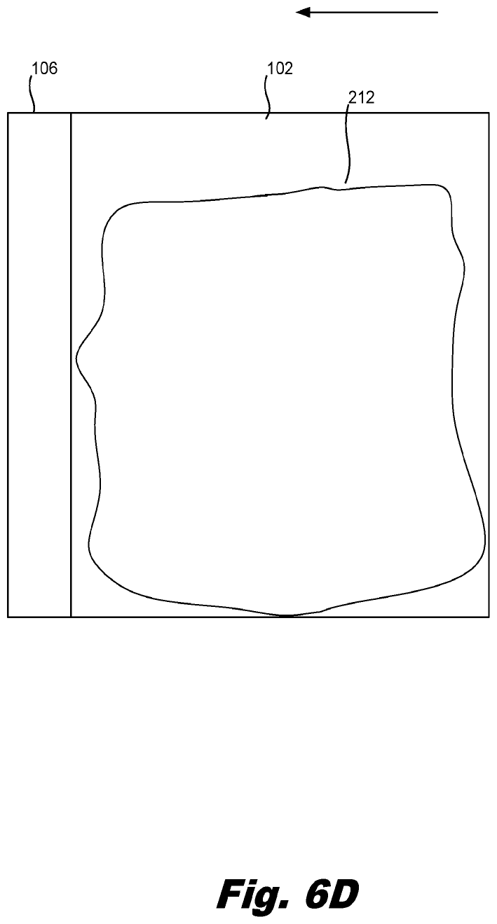

FIGS. 6A-6D are top views of an additive manufacturing system (100) for incrementally spreading a build material (212), according to an example of the principles described herein. In the example depicted in FIGS. 6A-6D, the build material spreader (106) traverses across the bed (102) in two directions to spread the build material (212). Specifically, as depicted in FIG. 6B, the build material spreader (106) traverses in a first direction thus spreading out the build material (212) across the bed (102). As depicted in FIG. 6C, following a raising of the bed (102), the build material spreader (106) traverses in a second direction thus spreading out the build material (212) to further thin the build material (212). As depicted in FIG. 6D, following a raising of the bed (102), the build material spreader (106) again traverses in the first direction thus spreading out the build material (212) even thinner.

In FIG. 6D, as the build material spreader (106) is on an opposite side of the bed (102) as compared to when in the initial position depicted in FIG. 6A, when forming a subsequent layer of the 3D printed object, build material (212) may be deposited on the opposite side of the bed (102). That is, build material (212) may be initially deposited on either side of the bed (102), and the build material spreader (106) may incrementally spread the build material (212) while moving in both directions.

Similar to FIGS. 4A-4D, FIGS. 6A-6D depict an example where the bed (102) is initially partially covered with build material (212) and where following a last pass, the entirety of the bed (102) is covered with build material. In another example, the bed (102) may initially be fully covered with build material (212). That is, with each pass, the bed (102) is fully covered with build material (212). In this example, following each pass of the build material spreader (106), as the build material (212) is thinned, excess build material (212) may spill off the edges of the bed (102) into a waste receptacle or waste transport system.

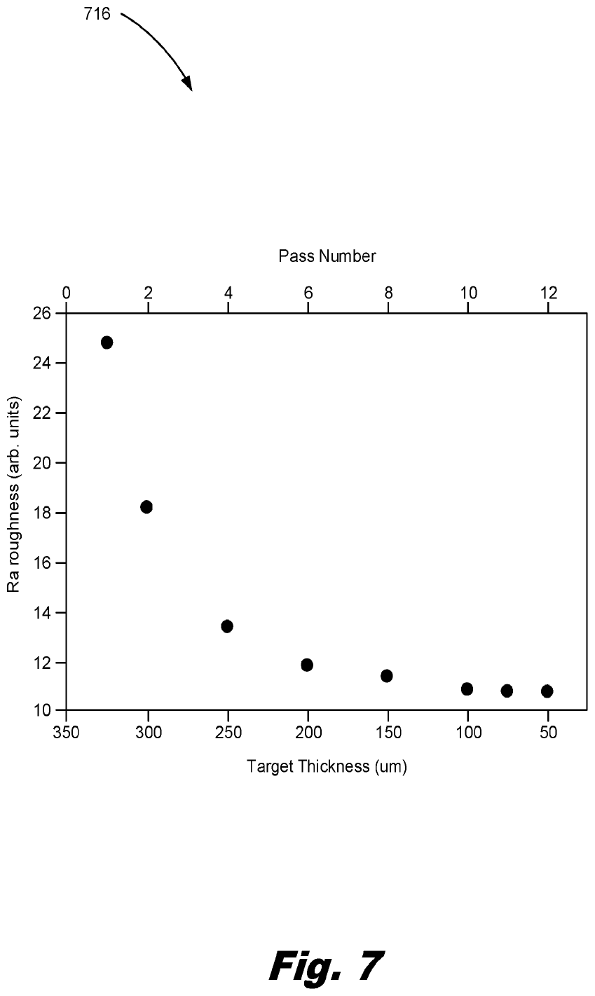

FIG. 7 is a graph (716) depicting a specific example of the surface roughness of build material (FIG. 2, 212), which in this example is stainless steel powder with particle diameters of 16 microns, (FIG. 2, 212) following incremental spreads of a build material (FIG. 2, 212), according to an example of the principles described herein. As described above, a multi-pass build material (FIG. 2, 212) spread operation provide for a smoother surface, which surface smoothness is an indicator of properties such as mechanical strength and dimensional accuracy of the 3D printed object. FIG. 7 depicts a relationship between a thickness of the build material (FIG. 2, 212) and the number of passes. FIG. 7 also depicts a relationship between the surface roughness and the number of passes. For example, after two passes, the build material (FIG. 2, 212) may be 300 microns thick and have a surface roughness of 18. By comparison, after 12 passes, the build material (FIG. 2, 212) may be 50 microns thick and have a surface roughness of 11. In this example, surface roughness is measured as “Ra” in the AMSE standard measurement of surface roughness using a laser scanner. This is defined as the arithmetic average of absolute values of the profile heat deviations from a mean line recorded with evaluation length. In other words, Ra is the average of a set of individual measurements of surface peaks and valleys. As it is an average value, there are no units attached. However, smaller Ra values indicate that the surface is smoother.

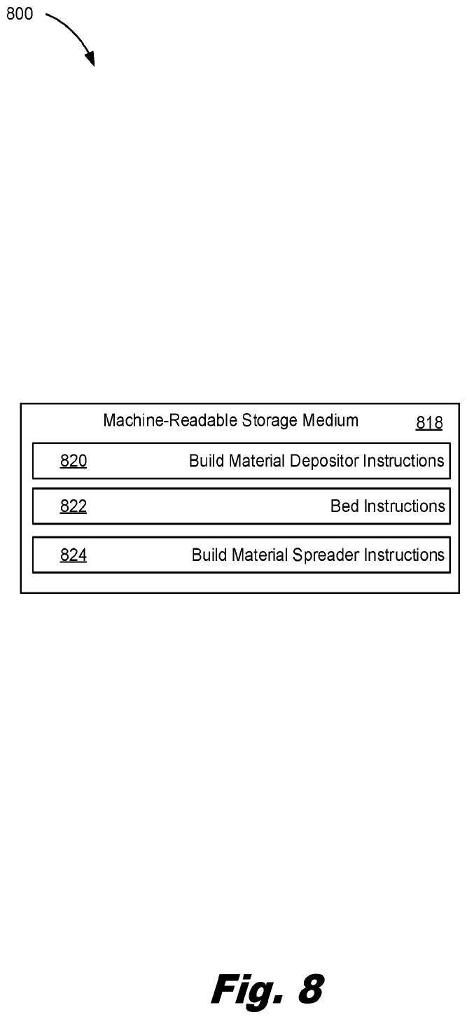

FIG. 8 depicts a non-transitory machine-readable storage medium (818) for incrementally spreading a build material (FIG. 2, 212), according to an example of the principles described herein. To achieve its desired functionality, the controller (FIG. 1, 108) includes various hardware components. Specifically, the controller (FIG. 1, 108) includes a processor and a machine-readable storage medium (818). The machine-readable storage medium (818) is communicatively coupled to the processor. The machine-readable storage medium (818) includes a number of instructions (820, 822, 824) for performing a designated function. The machine-readable storage medium (818) causes the processor to execute the designated function of the instructions (820, 822, 824). The machine-readable storage medium (818) can store data, programs, instructions, or any other machine-readable data that can be utilized to operate the additive manufacturing system (FIG. 1, 100). Machine-readable storage medium (818) can store computer readable instructions that the processor of the controller (FIG. 1, 108) can process, or execute. The machine-readable storage medium (818) can be an electronic, magnetic, optical, or other physical storage device that contains or stores executable instructions. Machine-readable storage medium (818) may be, for example, Random Access Memory (RAM), an Electrically Erasable Programmable Read-Only Memory (EEPROM), a storage device, an optical disc, etc. The machine-readable storage medium (818) may be a non-transitory machine-readable storage medium (818).

Referring to FIG. 8, build material depositor instructions (820), when executed by the processor, cause the processor to deposit an amount of build material (FIG. 2, 212) to form a layer of a 3D printed object on a bed (FIG. 2, 212) of an additive manufacturing system (FIG. 1, 100).

Bed instructions (822), when executed by the processor, may cause the processor to lower the bed (FIG. 2, 212) by an amount equal to a target layer thickness for the layer of the 3D printed object and lower the bed (FIG. 2, 212) by an additional amount. The bed instructions (822) are also executable by the processor to divide the additional amount into multiple increments and iteratively raise the bed (FIG. 2, 212) by an increment. Build material spreader instructions (824), when executed by the processor, may cause the processor to iteratively traverse a build material spreader (FIG. 1, 106) across the bed (FIG. 1, 102) to spread a portion of the build material (FIG. 2, 212) across the bed (FIG. 1, 102).

Accordingly, such systems and methods may 1) provide a smoother and more uniform surface for a layer of build material; 2) decrease mechanical defects in the 3D printed object; 3) increase geometric uniformity across the 3D printed object; 4) increase density of a layer; and 5) enhance the properties of a 3D printed object formed with non-spherical and non-uniform build material particles. However, it is contemplated that the systems and methods disclosed herein may address other matters and deficiencies in a number of technical areas.

What is claimed is:

1. An additive manufacturing system, comprising:
a bed moveable in a vertical direction, the bed to receive a build material that is to form a three-dimensional (3D) printed object;
a build material depositor to deposit the build material on the bed;
a build material spreader to traverse across the bed to spread the build material;
a solidification system to selectively solidify a layer of build material; and
a controller to:
lower the bed by a first amount in preparation for receiving build material; and
iteratively raise the bed in increments in between passes of the build material spreader across the bed, wherein an increment is a portion of the first amount.

2. The additive manufacturing system of claim 1, wherein build material associated with a single layer of the 3D printed object is spread in multiple passes of the build material spreader following iterative raising of the bed.

3. The additive manufacturing system of claim 1, wherein:
the first amount is greater than a target thickness of the layer of the 3D printed object; and
the bed is incrementally raised until it reaches a distance below the build material spreader that is equal to the target thickness.

4. The additive manufacturing system of claim 1, wherein the build material spreader is to traverse across the bed in two directions to spread the build material.

5. The additive manufacturing system of claim 1, wherein the build material depositor is to traverse across the bed to deposit the build material.

6. The additive manufacturing system of claim 1, wherein the build material depositor is stationary relative to the bed.

7. A method, comprising:
lowering a bed of an additive manufacturing system by a first amount, the first amount being greater than a target thickness for a layer of a three-dimensional (3D) printed object;
depositing an amount of build material to form the layer of the 3D printed object;
determining a difference between the first amount and the target layer thickness;
dividing the difference into multiple increments; and
iteratively:
raising the bed by an increment; and
traversing a build material spreader across the bed to spread a portion of the build material across the bed.

8. The method of claim 7, further comprising, following a last pass of the build material spreader, depositing a solidifying agent on the layer of build material to selectively solidify the build material to form the layer of the 3D printed object.

9. The method of claim 7, wherein increments of the multiple increments have different thicknesses.

10. The method of claim 9, wherein increments nearer a surface of the 3D printed object are thinner than increments further away from the surface of the 3D printed object.

11. The method of claim 7, wherein an increment is between 10-80 microns thick.

12. The method of claim 7, wherein an increment thickness is determined based on a property of a particle of the build material.

13. A non-transitory machine-readable storage medium encoded with instructions executable by a processor, the machine-readable storage medium comprising instructions to:
deposit an amount of build material to form a layer of a three-dimensional (3D) printed object on a bed of an additive manufacturing system;
lower the bed by an amount equal to a target thickness for the layer of the 3D printed object;
lower the bed by an additional amount;
divide the additional amount into multiple increments; and
iteratively:
raise the raisable bed by an increment; and
traverse a build material spreader across the bed to spread a portion of the build material across the bed.

14. The non-transitory machine-readable storage medium of claim 13, wherein the build material is a polymer build material.

15. The non-transitory machine-readable storage medium of claim 13, wherein the build material is a metallic or ceramic build material.
